(19) United States
(12) Patent Application Publication
(10) Pub. No.: US 2021/0079924 A1
(43) Pub. Date: Mar. 18, 2021

(54) VENTILATOR BACKFLOW PREVENTION DEVICE AND VENTILATOR INCLUDING SAME

(71) Applicant: PETRICHOR SWAN CO. LTD, Goyang-si, Gyeonggi-do (KR)

(72) Inventor: Su Wan KIM, Seoul (KR)

(21) Appl. No.: 17/046,900

(22) PCT Filed: Nov. 19, 2019
(86) PCT No.: PCT/KR2019/015795

§ 371 Date: Oct. 12, 2020

(30) Foreign Application Priority Data
Dec. 17, 2018 (KR) 10-2018-0163331
Mar. 5, 2019 (KR) 10-2019-0025408

(51) Int. Cl. F04D 25/14; F24F 7/007; F24F 13/10

(52) U.S. Cl. CPC F04D 25/14; F24F 13/10; F24F 7/007

(57) ABSTRACT

The present invention relates to a back flow prevention apparatus for a ventilator including: a shield part including an upper plate that covers one side of the ventilator through which indoor air is suctioned, a lower plate provided to a center of the upper plate, and a plate opening provided in the lower plate; and an opening/closing part fixed to the lower plate, and configured to close the plate opening by a self weight thereof and open the plate opening by a suction force of the ventilator, wherein the lower plate is formed at a lower position than the upper plate.

### TECHNICAL FIELD

The present invention relates to a back flow prevention apparatus for a ventilator and a ventilator including the same.

### BACKGROUND ART

In general, a ventilator is installed in an intake port of a duct embedded in a ceiling of a bath room or a kitchen requiring ventilation and discharge indoor smell and steam to the outside.

However, when the ventilator is not in operation, outside smells, dusts, insects or outdoor contaminants flow backward through ducts communicating with outside and enter indoors.

In particular, in case of multi-unit dwelling such as an apartment, there are multiple cases in which unpleasant matters such as food smells, toilet bad smells, tobacco smokes, or noises flow backward, and inter-floor smoking problems have recently appeared as hard-to-solve social conflict factors.

In order to prevent such a problem, a back flow prevention damper is installed inside a duct in related arts, but this has the following limitations.

First, in order to install a back flow prevention damper inside a duct, there was inconvenience in that an existing installed ventilator should be separated from a ceiling and reinstalled.

Next, when a ventilator was installed in a space, such as a bathroom or a kitchen, abundant in moisture, there was a problem in that indoor moisture could not completely escape and remain as it was and caused molds and bad smells.

Finally, in order to remove foreign substances or the like which fixedly adhered to a ventilator cover and thereby spoiled the exterior beauty, there was inconvenience in that screws fastened to the ventilator cover should be unfastened one by one and cleaned. Thus, related arts have many limitations.

### DISCLOSURE OF THE INVENTION

### Technical Problem

The present invention is devised to solve the limitations of related arts, and the purpose of the present invention is to provide a back flow prevention apparatus for a ventilator that is easily installable and uninstallable.

Another purpose of the present invention is to provide a dehumidifying function even while a ventilator is not in operation.

Still another purpose of the present invention is to beautify the exterior beauty of a ventilator.

### Technical Solution

According to an embodiment of the present invention, there is provided a back flow prevention apparatus for a ventilator including: a shield part including an upper plate configured to cover one side of the ventilator through which indoor air is suctioned, a lower plate provided to a center of the upper plate, and a plate opening provided in the lower plate; and an opening/closing part that is fixed to the lower plate, configured to close the plate opening by a self weight thereof and open the plate opening by a suction force of the ventilator, wherein the lower plate is formed at a lower position than the upper plate.

In an exemplary embodiment, the back flow prevention apparatus may further include: a bracket to which the shield part is fastened; and a bracket fixing member configured to attach the bracket to a ceiling on which the ventilator is installed, wherein the shield part may further include a first attachment/detachment part, and the bracket may include a first attachment/detachment part accommodation part selectively fastened to the first attachment/detachment part.

In an exemplary embodiment, the shield part may further include a sealing rib provided on a periphery of the upper plate, and the bracket may further include an insertion rib engaged with the sealing rib.

In an exemplary embodiment, the back flow prevention apparatus may further include a sealing member inserted into the sealing rib, wherein the sealing rib may include: an inner rib protruding upward from an end section of the upper plate; and an outer rib provided outside the inner rib to form a recess together with the inner rib, and the sealing member is inserted into the recess and pressed by the insertion rib.

In an exemplary embodiment, the back flow prevention apparatus may further include an opening/closing part holder configured to fix a center of the opening/closing part, wherein the opening/closing part may include a flexible material so as to be bent by a suction force of the ventilator and open the plate opening.

In an exemplary embodiment, the opening/closing part holder may include: a protruding part configured to fix a central section of the opening/closing part to the lower plate so that the central section of the opening/closing part is fixed to the lower plate and an outer peripheral section of the opening/closing part is lifted as the ventilator operates; and a holder body provided in parallel with the opening/closing part, extending radially outward from an upper end of the protruding part, and configured to limit a bending range of the opening/closing part.

In an exemplary embodiment, a radius of the holder body may be smaller than a radius of the opening/closing part so that when the opening/closing part is lifted by the suction force of the ventilator, the outer peripheral section of the opening/closing part may not be in contact with one side of the ventilator, and a height of the opening/closing part may be greater than a height of an outer peripheral part of the holder body.

In an exemplary embodiment, the holder body may further include body through-holes facing the opening/closing part.

In an exemplary embodiment, the opening/closing part holder may further include a fastening rib selectively fastened to the lower plate, and the lower plate may include a fastening rib insertion hole.

In an exemplary embodiment, the back flow prevention apparatus may further include a cover configured to cover a lower surface of the shield part and including a plurality of through-holes to which indoor air is suctioned, wherein the cover may be selectively attached/detached to/from the shield part.

In an exemplary embodiment, the back flow prevention apparatus may further include a dehumidification part provided between the shield part and the cover, configured to suction moisture in indoor air when an operation of the ventilator is stopped, and configured to discharge suctioned moisture when the ventilator operates, wherein the cover may include a dehumidification part fixing rib that suppresses fluctuation of the dehumidification part.

According to an embodiment of the present invention, there is provided a back flow prevention apparatus for a ventilator including: a fan configured to suction indoor air; a fan housing to which the fan is attached; a fan cover configured to cover a lower side of the fan housing; a shield part including an upper plate configured to cover a lower side of the fan cover, a lower plate provided at a center of the upper plate, and a plate opening provided to the lower plate; and an opening/closing part fixed to the lower plate, and configured to close the plate opening by a self weight thereof and open the plate opening by a suction force of the ventilator, wherein the lower plate is formed at a lower position than the upper plate.

According to an embodiment of the present invention, there is provided a back flow prevention apparatus for a ventilator including: a shield part configured to cover one side of the ventilator through which indoor air is suctioned and including a plate opening; an opening/closing part fixed to a plate, and configured to close the plate opening by a self weight thereof and open the plate opening by a suction force of the ventilator; a cover configured to cover a lower surface of the shield part and including a plurality of through-holes through which indoor air is suctioned; and a dehumidification part provided between the shield part and the cover.

In an exemplary embodiment, the dehumidification part may suction indoor moisture when the ventilator is not in operation, and may be dried by a flow of air introduced via the plurality of through-holes and flowing toward the plate opening when the ventilator operates.

In an exemplary embodiment, the cover may be provided so as to be selectively attached/detached to/from the shield part, and the dehumidification part may be extracted to an outside in a state in which the cover is detached from the shield part.

### BRIEF DESCRIPTION OF THE DRAWINGS

FIG. 1 is a perspective view of a lower portion of a back flow prevention apparatus for a ventilator according to an embodiment of the present invention.

FIG. 2 is an exploded perspective view of a back flow prevention apparatus for a ventilator according to an embodiment of the present invention.

FIG. 3 is a perspective view of an upper portion of a back flow prevention apparatus for a ventilator according to an embodiment of the present invention.

FIG. 4 is a side cross-sectional view of a back flow prevention apparatus for a ventilator according to an embodiment of the present invention.

FIG. 5 is a perspective view of an upper portion of a shield part of the back flow prevention apparatus for a ventilator.

FIG. 6 illustrates a bracket of the back flow prevention apparatus for a ventilator.

FIG. 7 illustrates an opening/closing part of the back flow prevention apparatus for a ventilator.

FIG. 8 illustrates an opening/closing part holder of the back flow prevention apparatus for a ventilator.

FIG. 9 is a perspective view of a lower portion of the shield part of the back flow prevention apparatus for a ventilator.

FIG. 10 illustrates a cover of the back flow prevention apparatus for a ventilator.

FIG. 11 illustrates another embodiment of the back flow prevention apparatus for a ventilator.

FIG. 12 illustrates still another embodiment of the back flow prevention apparatus for a ventilator.

FIG. 13 is a side cross-sectional view of a ventilator including a back flow prevention apparatus for a ventilator.

FIG. 14 is a perspective view of a back flow prevention apparatus for a ventilator according to an embodiment of the present invention.

FIG. 15 illustrates another embodiment of the bracket.

### MODE FOR CARRYING OUT THE INVENTION

Hereinafter, various embodiments of the present invention will be described with reference to drawings.

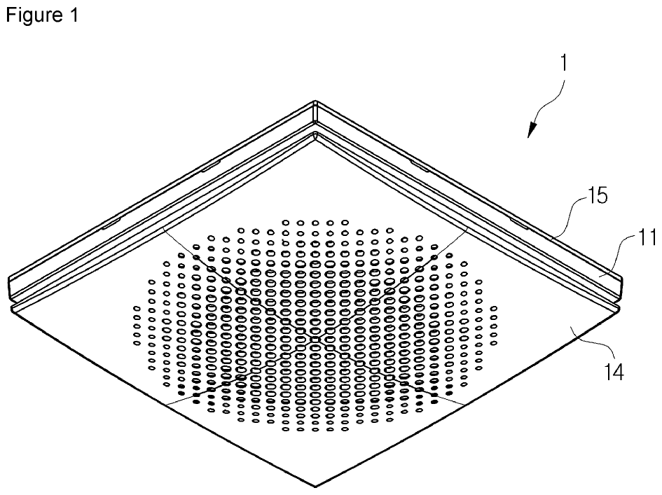

First, referring to FIG. 1, a back flow prevention apparatus 1 for a ventilator according to an embodiment of the present invention may be installed on one side of the ventilator through which indoor air is suctioned and prevent contaminants from flowing backward to an indoor side through a duct when the ventilator is not in operation.

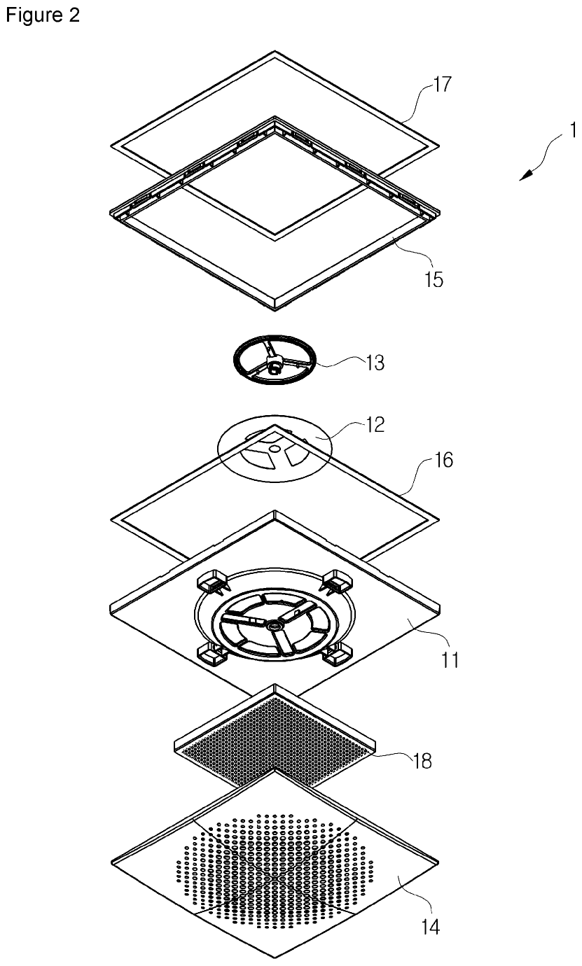

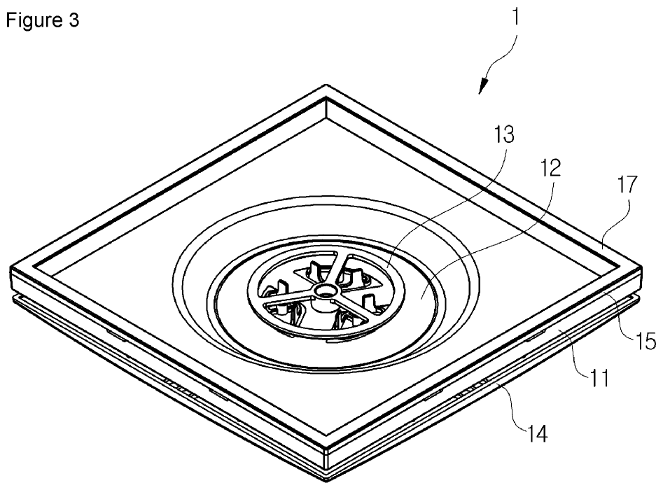

Hereinafter, with reference to FIGS. 2 and 3, the entire configuration of the back flow prevention apparatus 1 for a ventilator will be described in detail.

The back flow prevention apparatus 1 for a ventilator according to an embodiment of the present invention may include: a shield part 11 which covers one side of the ventilator through which indoor air is suctioned and includes a plate opening 1112a through which air flows; an opening/closing part 12 which is fixed to the shield part 11, closes the plate opening 1112a by a self weight thereof, and opens the plate opening 1112a by a suction force of the ventilator; a bracket 15 to which the shield part is selectively fastened; and a bracket fixing member 17 which is provided as a double-sided adhesive pad for attaching the bracket 15 to a ceiling to which the ventilator is installed.

Accordingly, when a fan of the ventilator rotates, the shield part 12 opens the plate opening 1112a, and when the rotation of the ventilator fan is stopped, the opening/closing part 12 closes the plate opening 1112a, and thus, the problem may be prevented in which contaminants flow backward to an indoor side.

In addition, the back flow prevention apparatus a for a ventilator according to an embodiment of the present invention may further include: a cover 14 which covers a lower surface of the shield part 11 and is provided with a plurality of through-holes 141a through which indoor air is suctioned; and a dehumidification part 18 which is provided between the shield part 11 and the cover 14, suctions moisture in indoor air when the operation of the ventilator is stopped, and discharges suctioned moisture when the ventilator operates.

The dehumidification part 18 may include a dehumidification agent that suctions and discharges moisture and is provide as a plurality of particles, and a bag for storing the dehumidification agent.

The dehumidification agent may be composed of a multi-function porous material based on red clay, zeolite, or activated carbon, and be provided so as to further achieving air freshening function aside from a dehumidifying function by adding an air freshening component.

Meanwhile, the back flow prevention apparatus 1 for a ventilator according to an embodiment of the present invention may further include a sealing member 16 that prevents the indoor air suctioned through the shield part 11 from leaking between the shield part 11 and the bracket 15.

The sealing member 16 may be composed of a sealing member such as rubber or a synthetic resin, and a structure to which the sealing member 16 is attached will be described later in detail.

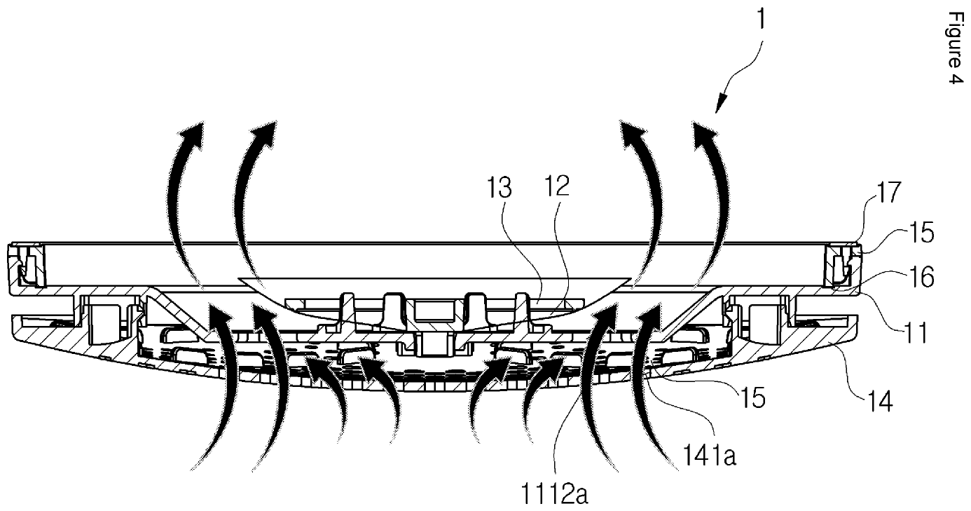

Referring to FIG. 4, an operating state of the back flow prevention apparatus 1 for a ventilator when a ventilator fan rotates will be described.

When a negative pressure is generated by the ventilator fan, an end section of the opening/closing part 12 moves upward, and accordingly, while the through-holes 141a of the cover 14 and the plate opening 1112a communicates with each other, indoor air may be discharged through a duct.

Meanwhile, when the rotation of the ventilator fan is stopped, the opening/closing part 12 closes the plate opening 1112a by a downward movement of the end section, and contaminants flowing backward through the duct may be blocked by the opening/closing part 12.

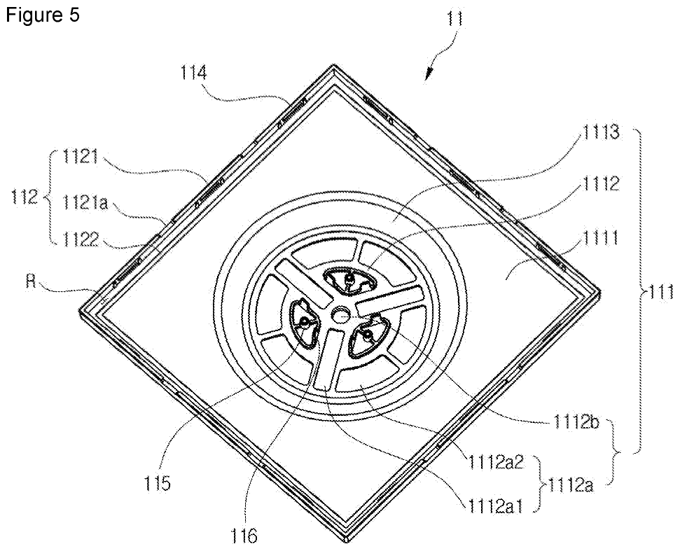

Hereinafter, referring to FIG. 5, the structure of the shield part 11 will be described in more detail.

The shield part 11 may include a shield plate 111, and the shield plate may include a plate-like upper plate 1111 and a lower plate 1112 positioned at the center of the upper plate 1111.

In addition, the lower plate 1112 may be provided with a plate opening 1112a through which indoor air is suctioned, and the plate opening 1112a may include a plurality of first openings 1112a1 provided in the circumferential direction of the lower plate 1112.

The first openings 1112a1 are provided along the periphery of the lower plate 1112 having the strongest suction force generated by the ventilator fan, and thus, the opening/closing part 12 may easily be lifted.

Furthermore, the plate opening 1112a may include second openings 1112a2 radially formed from the central portion of the lower plate 1112, and thus, an effect of lifting the opening/closing part 12 may be maximized by efficiently using gap spaces between opening/closing part vertical movement guiders 115 to be described later.

Meanwhile, the lower plate 1112 may be provided at a lower position than the upper plate 1111, and the lower plate 1112 and the upper plate 1111 may be connected via a connection part 1113 inclined a predetermined angle toward the center of the lower plate 1112.

Accordingly, a lift able height of the opening/closing part 12 is ensured, and thus, the problem may be prevented in which the opening/closing part 12 shields the cover of the ventilator and reduces a suction force.

Meanwhile, the shield part 11 may further include opening/closing part vertical movement guiders 115 that protrude upward from the lower plate 1112 and formed radially inside the first openings 1112a1.

The opening/closing part vertical movement guiders 115 may be inserted into guide holes 121a of the opening/closing part 12 and function to prevent the opening/closing part 12 from being inwardly folded after being lifter by a suction force.

The shield part 11 may further include a sealing rib 113 protruding upward along the periphery of the upper plate 1111, and the sealing rib 113 may include: an inner rib 1132 protruding upward from end sections of the upper plate; and an outer rib 1131 which is provided radially outside the inner rib 1132 and forms a recess R with the inner rib 1132.

The inner rib 1132 and the outer rib 1131 may prevent contaminants of the duct from leaking through a coupling space of the bracket 15 and the shield part 11, and prevent a decrease in the suction force of the ventilator.

Furthermore, the sealing member 16 may be inserted in the recess R formed by the inner rib 1132 and the outer rib 1131, and this may maximize the sealing property between the bracket 15 and the shield part 11.

Meanwhile, the shield part 11 may further include a first attachment/detachment part 114 protruding on the inner peripheral surface of the outer rib 1131, and the first attachment/detachment part 114 may be selectively fastened to a first attachment/detachment part accommodation part 153 of the bracket 15.

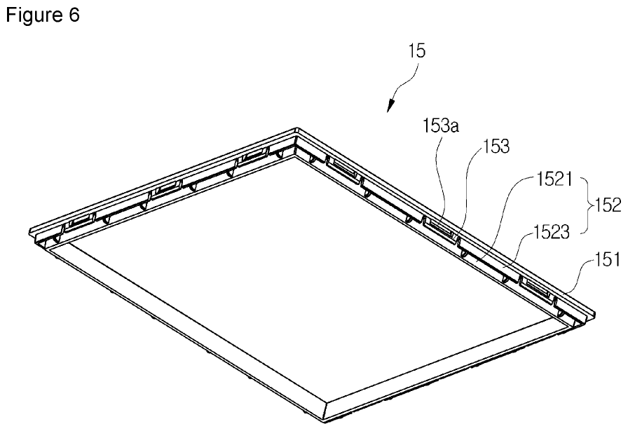

Hereinafter, referring to FIG. 6, the fastening type and the structure of the bracket 15 will be described in more detail.

The bracket 15 may include: a bracket frame 151 to which the bracket fixing member 17 is attached; and a first attachment/detachment part accommodation part 153 selectively fastened to the first attachment/detachment part 114.

The first attachment/detachment part 153 may protrude downward from the bracket frame 151, and accommodating grooves 153a are provided in the first attachment/detachment part 153, and thus, the first attachment/detachment part 114 may be selectively inserted into the accommodating grooves.

Furthermore, the bracket may further include an insertion rib 152 to be engaged with the sealing rib 113, and the upper surface of the sealing member 16 may be pressurized by the insertion rib 152.

The insertion rib 152 may include: a first rib 1521 in contact with the inner rib 1132; and a second rib 1523 provided outside the first rib 1521 so as to be in contact with the outer rib 1131.

Accordingly, a more high level of sealing property may be guaranteed by effectively pressurizing both ends of the upper surface of the sealing member 17.

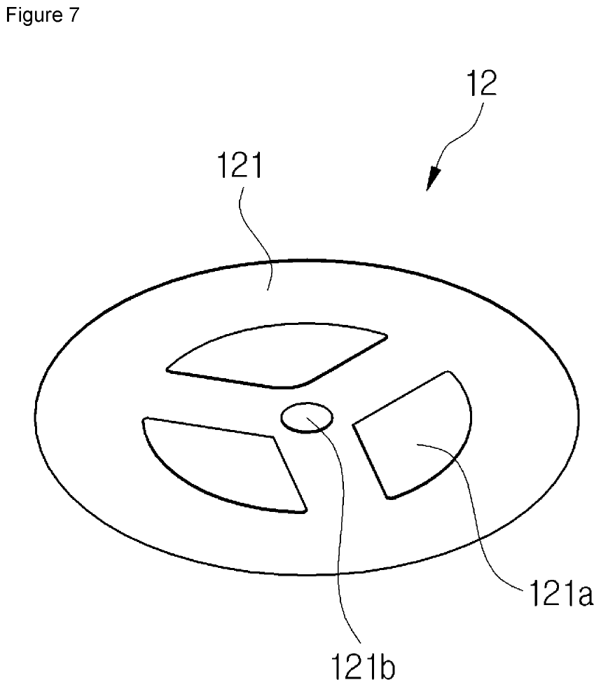

Hereinafter, referring to FIG. 7, the structure of the opening/closing part 12 will be described in more detail.

The opening/closing part 12 may include: an opening/closing body 121 composed of at least one flexible material among silicon or rubber so as to be bent by the suction force of the ventilator and open the plate opening; and guide holes 121a which are formed in the opening/closing body 121 and in which the opening/closing part vertical movement guiders 115 are inserted.

The opening/closing body 121 is favorably provided in a disk shape, but may be provided in a rectangular plate or a polygonal plate according to need.

The opening/closing part 12 may further include a fastening rib through hole 121b which is formed in the center of the opening/closing body 121 and in which a fastening rib 133 of an opening/closing part holder 13 is inserted.

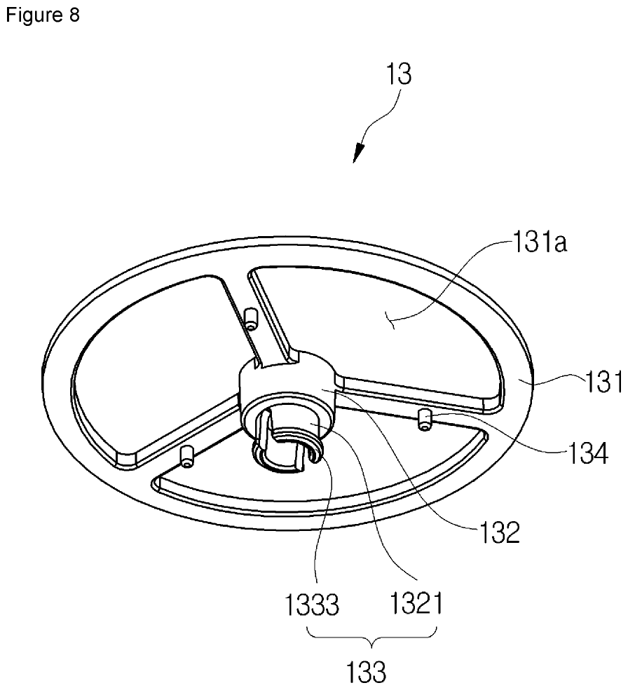

Referring to FIG. 8, when further describing a detailed structure of the opening/closing part holder 13, the opening/closing part holder 13 may include: a holder body 131; a protruding part 132 for fixing the center of the opening/closing part 12 to the lower plate 1112; and a fastening rib 133 provided on a lower portion of the holder body 131 and fixed to the lower plate 1112.

In addition, the fastening rib 133 may include: an insertion part 1321 which is selectively inserted into a fastening rib insertion hole 1112b provided on the center of the lower plate 1112 and having a peripheral length variable according to external force; and a stepped part 1333 which is formed on the free end of the insertion part 1321 and hooked on the lower surface of the lower plate 1112.

The insertion part 1321 may be formed in a plurality of protruding ribs having a circular outer circumferential surface, and the circumferential length of the insertion part may be variable.

The holder body 131 may be provided in parallel with the opening/closing part 12 and provided in a plate shape that limits the bending range of the opening/closing part 12, and a plurality of body through-holes 131a facing the opening/closing part 12 with each other.

The body through-holes 131a may function to maximize the lifting function of the opening/closing part 12 by causing the suction force of the ventilator not to bypass the holder body 131 outward but to be directly transmitted to the opening/closing part 12.

Meanwhile, the opening/closing holder 13 may further be provided with auxiliary protrusions 134 protruding downward from the holder body 131, and the lower plate 1112 may be provided with auxiliary protrusion accommodation parts 116 selectively coupled to the auxiliary protrusions 134.

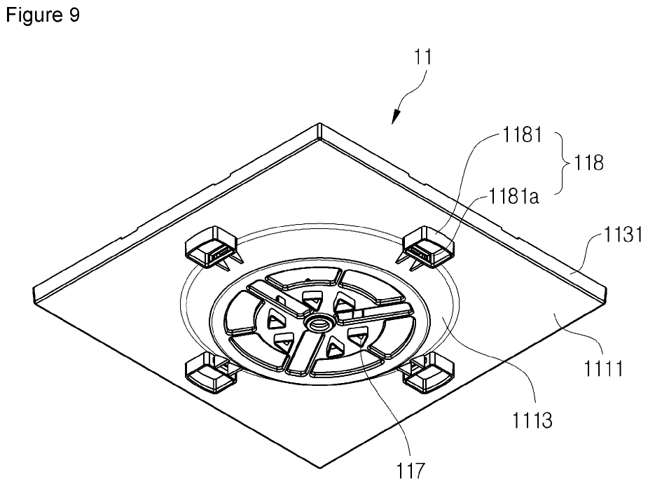

Hereinafter, referring to FIG. 9, a lower structure of the shield part 11 will be described in more detail.

The shield part 11 may further include dehumidification part pressing parts 117 protruding downward from the lower surface of the lower plate 1112, and the dehumidification part pressing parts 117 may prevent fluctuation of the dehumidification part 18 by pressing the upper surface of the dehumidification part 18.

In addition, the shield part 11 may further include second attachment/detachment parts 118 which are provided on the lower surface of the upper plate 1111 and selectively fastened to insertion/extraction ribs 1431 of the cover 14.

The second attachment/detachment parts 118 may each include: an insertion/extraction rib accommodation part 181; and a cover hook insertion hole 1181a formed in the insertion/extraction rib accommodation part 181.

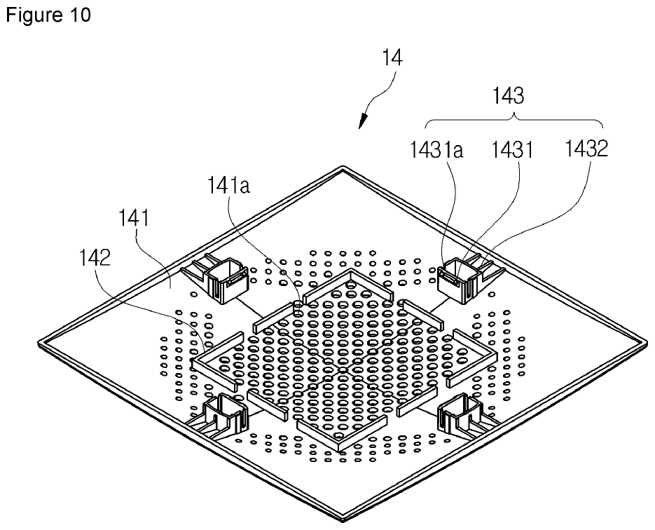

Referring to FIG. 10, a structure for attaching/detaching the cover 14 to the shield part 11 and remaining detailed structures will be described

The cover 14 may include: a cover plate 141 having a flat plate shape or a plate shape having a predetermined downward curvature; and cover attachment/detachment parts 143 which are provided on the upper surface of the cover plate 141 and selectively fastened to the second attachment/detachment parts 143.

The cover attachment/detachment parts 143 may each include: an insertion/extraction rib 1431 having a hollow pillar shape; and a cover hook 1432 which protrudes from one side of the insertion/extraction rib 1431 and may be selectively inserted/extracted to/from the cover hook insertion holes 1181a.

In addition, a cut part 1431 may be formed in the insertion/extraction rib 1431 in the lengthwise directions of the insertion/extraction rib 1431, and the peripheral length of the insertion/extraction rib 1431 may be varied so that the cover hook 1432 may easily be inserted into the cover hook insertion hole 1181a.

Meanwhile, the cover 14 may further include dehumidification fixing ribs 142 which prevent horizontal fluctuation of the dehumidification part 18.

Summarizing an effect due to the above-described fastening structures, the shield part 11 is easily attached/detached to/from the bracket 15, so that the opening/closing part 12 to which foreign substances are fixedly adhered may be conveniently replaced, and likewise, the cover 14 is easily attached/detached to/from the shield part 11, so that the dehumidification part 18 running out of the service life thereof may easily be replaced.

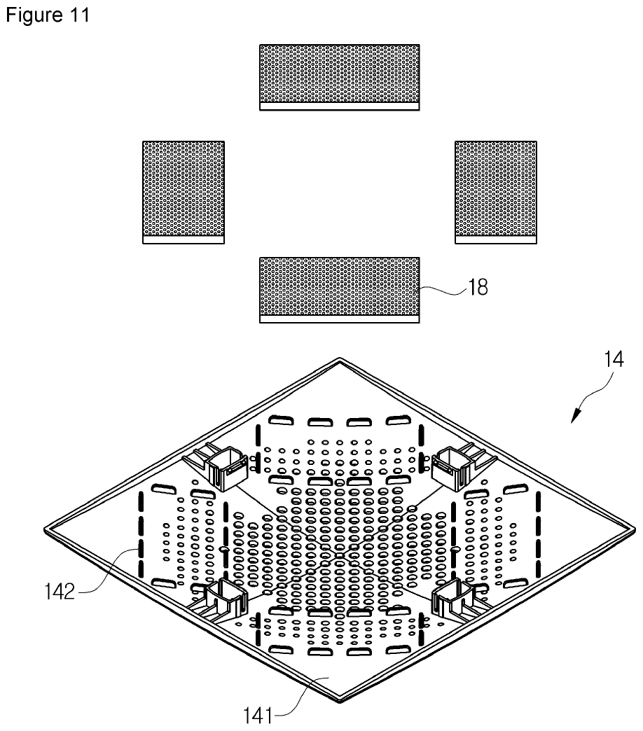

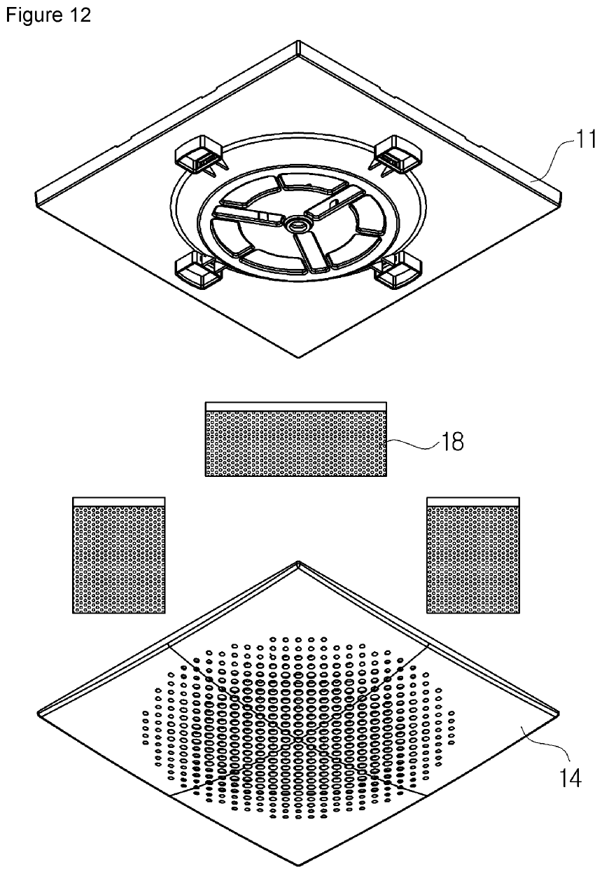

Next, referring to FIGS. 11 and 12, a configuration of a back flow prevention apparatus for a ventilator according to another embodiment of the present invention will be described.

Describing only differences from the above-described embodiments in order to avoid repeated descriptions, a plurality of dehumidification parts 18 may be provided and be provided between a cover 14 and a shield part 111 so as to be adjacent to edges of a cover plate 141.

In other words, the dehumidification parts are provided on an outer side of a space under a plate opening 1112a of the shield part 11, and thus, a problem may be prevented in which the suction force of a ventilator is degraded due to resistance of the dehumidification parts 18 and noises are caused by a vortex flow.

Accordingly, in the cover 14, dehumidification part fixing ribs 142 for preventing horizontal fluctuation of the dehumidification parts 18 may also be positioned on an outer side of a space under the plate opening 1112a of the shield part 11.

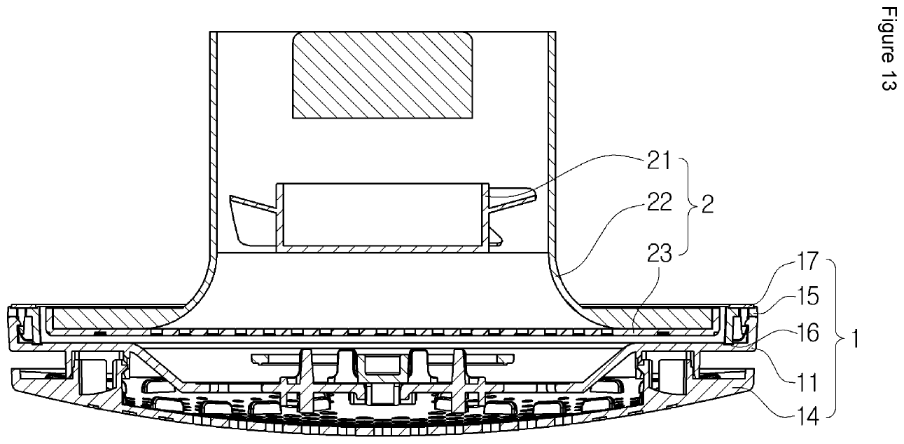

Referring to FIG. 13, a ventilator 2 will be described which includes a back flow prevention apparatus 1 according to an embodiment of the present invention.

The ventilator 2 according to an embodiment of the present invention may include: a fan 21 for suctioning indoor air; a fan housing 22 to which the fan 21 is attached; and a fan cover 23 for covering a lower side of the fan housing 22.

In addition, the ventilator 2 may include the above-described back flow prevention apparatus 1, and the bracket 15 may be fixed to a ceiling or a lower surface of the fan cover 23 through the bracket fixing member 17.

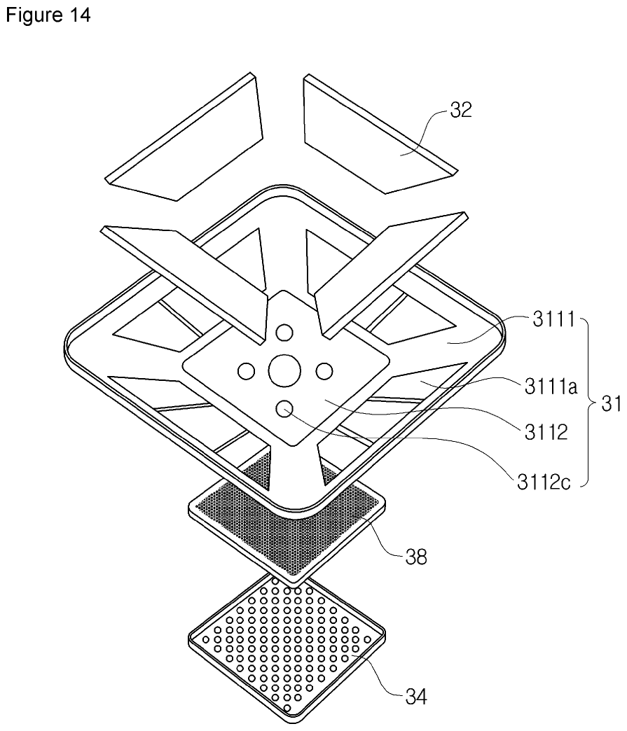

FIG. 14 is a perspective view of a back flow prevention apparatus for a ventilator according to an embodiment of the inventive concept.

In order to avoid repeated descriptions, differences from the one embodiment described above will be mainly described.

A back flow prevention apparatus for a ventilator according to another embodiment of the present invention may include a shield part 31 for covering one side of the ventilator, and the shield part 31 may include: an upper plate 3111 formed in an inclining surface; and a lower plate 3112 positioned at the center of the upper plate 3111.

In addition, a plurality of plate openings 3111a may be provided in the peripheral direction of the upper plate 3111 unlike the above-described embodiment, and the upper end of an opening/closing part 32 may be fixed to one side of the plurality of plate openings 3111a.

Accordingly, when the ventilator operates, the opening/closing part 32 may be lifted and open the plate openings 3111a.

Meanwhile, the cover 34 may be provided so as to cover only a lower surface of the lower plate 3111 excluding the upper plate 3111, and a dehumidification part 38 may be provided between the lower plate 3111 and the cover 34.

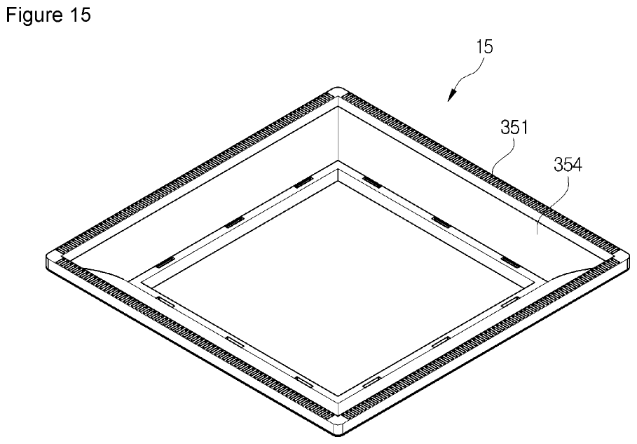

FIG. 15 illustrates another embodiment of a bracket, which has a configuration applicable to a case in which the size of an existing installed ventilator.

The bracket 35 may include: a bracket frame 351 to which a bracket fixing member 17 is attached; a first attachment/detachment part accommodation part 153 selectively fastened to a first attachment/detachment part 114; and an expanded plate 354 which connects the bracket frame 351 and the first attachment/detachment part accommodation part 153.

The expanded plate 354 may be provided so that the periphery of a lower end outer peripheral part is smaller than the periphery of the upper end outer peripheral part, and the first attachment/detachment accommodation part 153 and an insertion rib 152 may be provided on a lower end of the expanded plate 354.

Accordingly, a back flow prevention apparatus for a ventilator applied also to a large-sized ventilator having a general-purpose size by only replacing the bracket 35, and thus, the compatibility of the apparatus may be maximized.

That is, in case of a large-sized ventilator, a problem, in which since a fan cover 23 for covering a lower side of the fan housing 22 is larger than the ventilator with a general-purpose size, and an existing back flow prevention apparatus for a ventilator is difficult to install, may easily be solved by the expanded plate 354.

In the present invention, the above-described configurations may further have other effects even the effects are not described in this specification, and a new effect that have not been exhibited in related arts may be derived according to organic coupling relationships between the above-described configurations.

In addition, the embodiments illustrated in the drawings may be carried out by being modified into other forms, and should be construed to be included in the claim of the present invention when carried out including the configuration set forth in claims of the present invention or when carried out within an equivalent scope.

1. A back flow prevention apparatus for a ventilator comprising:
a shield part including an upper plate configured to cover one side of the ventilator through which indoor air is suctioned, a lower plate provided to a center of the upper plate, and a plate opening provided in the lower plate; and
an opening/closing part fixed to the lower plate, and configured to close the plate opening by a self weight thereof and open the plate opening by a suction force of the ventilator,
wherein the lower plate is formed at a lower position than the upper plate.

2. The back flow prevention apparatus of claim 1, further comprising:
a bracket to which the shield part is fastened; and
a bracket fixing member configured to attach the bracket to a ceiling on which the ventilator is installed,
wherein the shield part further comprises a first attachment/detachment part, and
the bracket comprises a first attachment/detachment part accommodation part selectively fastened to the first attachment/detachment part.

3. The back flow prevention apparatus of claim 2, wherein the shield part further comprises a sealing rib provided on a periphery of the upper plate, and
the bracket further comprises an insertion rib engaged with the sealing rib.

4. The back flow prevention apparatus of claim 3, further comprising a sealing member inserted into the sealing rib, wherein the sealing rib comprises:
an inner rib protruding upward from an end section of the upper plate; and
an outer rib provided outside the inner rib and configured to form a recess together with the inner rib, and
the sealing member is inserted into the recess and pressed by the insertion rib.

5. The back flow prevention apparatus of claim 1, further comprising an opening/closing part holder configured to fix a center of the opening/closing part, wherein the opening/closing part comprises a flexible material so as to be bent by a suction force of the ventilator and open the plate opening.

6. The back flow prevention apparatus of claim 5, wherein the opening/closing part holder comprises:
a protruding part configured to fix a central section of the opening/closing part to the lower plate so that the central section of the opening/closing part is fixed to the lower plate and an outer peripheral section of the opening/closing part is lifted as the ventilator operates; and
a holder body provided in parallel with the opening/closing part, extending radially outward from an upper end of the protruding part, and configured to limit a bending range of the opening/closing part.

7. The back flow prevention apparatus of claim 6, wherein:
a radius of the holder body is smaller than a radius of the opening/closing part so that when the opening/closing part is lifted by the suction force of the ventilator;
the outer peripheral section of the opening/closing part is not in contact with one side of the ventilator; and
a height of the opening/closing part is greater than a height of an outer peripheral part of the holder body.

8. The back flow prevention apparatus of claim 6, wherein the holder body comprises a body through-hole facing the opening/closing part.

9. The back flow prevention apparatus of claim 5, wherein
the opening/closing part holder comprises a fastening rib selectively fastened to the lower plate, and
the lower plate comprises a fastening rib insertion hole.

10. The back flow prevention apparatus of claim 1, further comprising a cover configured to cover a lower surface of the shield part and comprising a plurality of through-holes to which indoor air is suctioned,
wherein the cover is selectively attached/detached to/from the shield part.

11. The back flow prevention apparatus of claim 1, further comprising a dehumidification part provided between the shield part and the cover, configured to suction moisture in indoor air when an operation of the ventilator is stopped, and configured to discharge suctioned moisture when the ventilator operates,
wherein the cover comprises a dehumidification part fixing rib configured to suppress fluctuation of the dehumidification part.

12. A back flow prevention apparatus for a ventilator comprising:
a fan configured to suction indoor air;
a fan housing to which the fan is attached;
a fan cover configured to cover a lower side of the fan housing;
a shield part including an upper plate configured to cover a lower side of the fan cover, a lower plate provided at a center of the upper plate, and a plate opening provided to the lower plate; and
an opening/closing part fixed to the lower plate, and configured to close the plate opening by a self weight thereof and open the plate opening by a suction force of the ventilator,
wherein the lower plate is formed at a lower position than the upper plate.

13. A back flow prevention apparatus for a ventilator comprising:
a shield part configured to cover one side of the ventilator through which indoor air is suctioned and including a plate opening;
an opening/closing part fixed to a plate, and configured to close the plate opening by a self weight thereof and open the plate opening by a suction force of the ventilator;
a cover configured to cover a lower surface of the shield part and comprising a plurality of through-holes through which indoor air is suctioned; and
a dehumidification part provided between the shield part and the cover.

14. The back flow prevention apparatus of claim 13, wherein the dehumidification part suctions indoor moisture when the ventilator is not in operation, and is dried by a flow of air introduced via the plurality of through-holes and flowing toward the plate opening when the ventilator operates.

15. The back flow prevention apparatus of claim 14, wherein:
the cover is provided so as to be selectively attached/detached to/from the shield part; and
the dehumidification part is extractable to an outside in a state in which the cover is detached from the shield part.
